(19) United States
(12) Patent Application Publication
(10) Pub. No.: US 2026/0295698 A1
(43) Pub. Date: Oct. 1, 2026

(54) METHOD FOR DRESSING A MULTI-THREAD GRINDING WORM WITH A MULTI-GROOVE DRESSING ROLL AND METHOD FOR GRINDING A GEAR USING A MULTI-THREAD GRINDING WORM

(71) Applicants: KAPP NILES GmbH & Co. KG, Coburg (DE); Volkswagen Aktiengesellschaft, Wolfsburg (DE)

(72) Inventors: Frank MUELLER, Meeder (DE); Patrick DUHRE, Coburg (DE); Maxim KINDSVATER, Wolfsburg (DE); Todor RADEV, Wolfsburg (DE); Stefan HAMMERSCHLAG, Wolfsburg (DE); Georg-Friedrich LUEHRS, Wolfsburg (DE)

(21) Appl. No.: 19/630,872

(22) Filed: Mar. 27, 2026

(30) Foreign Application Priority Data
Mar. 28, 2025 (DE) 10 2025 112 302.0

(51) Int. Cl. B23F 23/12; B23F 1/02

(52) U.S. Cl. CPC B23F 23/1231; B23F 1/023

(57) ABSTRACT

A method for dressing a multi-thread grinding worm with a multi-groove dressing roll. The grinding worm has a plurality of parallel worm threads that run around a tool axis. The dressing roll has a number of dressing surfaces which are arranged adjacent to one another along a dressing tool axis and which are tooth-shaped in radial section. For dressing the grinding worm, the dressing roll is brought into engagement with the worm threads. In order to correctly perform the dressing process with a correspondingly non-equal-pitch dressing roll in the case of non-equal-pitch toothing, the dressing roll is inserted several times into adjacent worm threads, centered there, and fed radially until the deepest feed amount is reached, which indicates the correct relative position between the dressing roll and the grinding worm. The same applies to the method for grinding a gear with a non-equal-pitch toothing using a multi-thread grinding worm.

### CROSS-REFERENCE TO RELATED APPLICATIONS

the present application claims priority of de 10 2025 112 302.0, filed Mar. 28, 2025, the priority of this application is hereby claimed, and this application is incorporated herein by reference.

### BACKGROUND OF THE INVENTION

The invention relates to a method for dressing a multi-thread grinding worm with a multi-groove dressing roll, wherein the grinding worm has several worm threads that run parallel to each other around a tool axis, wherein the dressing roll has a number of dressing surfaces which are arranged adjacent to one another along a dressing tool axis and which are tooth-shaped in radial section, wherein the dressing roll is brought into engagement with the worm threads for dressing the grinding worm. Furthermore, the invention relates to a method for grinding a gear using a multi-thread grinding worm, wherein the grinding worm has several worm threads that run parallel to each other around a tool axis, wherein the gear has teeth that are unevenly spaced along the circumference of the gear and/or differ in shape from one another.

The operation of gears inevitably generates noise, which can be minimized by high-quality hard finishing, but can never be completely avoided. Regular noises (noises with a tonal character) are usually perceived as more unpleasant than noises with a noise-like character. In order to reduce the regularity of noise generation in a gear in operation, the use of gears with so-called non-equidistant toothing can be considered. For the state of the art in this regard, reference is made to DE 35 33 743 A1.

Due to the non-equidistant spacing between teeth, the production of such a toothing is more problematic than in the case of classic equidistant toothing. Profile grinding is a suitable hard finishing process for the production of non-equidistant toothings, in which each tooth gap is ground separately for each flank in order to produce the desired non-equidistance.

However, the disadvantage of this method is that it is time-consuming and the gears produced are correspondingly expensive.

For the technological background of gear grinding, reference is made, for example, to DE 43 30 930 A1. Further similar and other solutions are shown in DE 199 10 747 A1, DE 197 20 624 A1, DD 286 530 A5, DE 10 2017 121 344 A1, DE 202 03 661 U1, JP 2000 326 141 A, and DE 100 01 848 A1.

### SUMMARY OF THE INVENTION

The invention is based on the object of further developing a method of the type mentioned above in such a way that it is possible to manufacture gears or workpieces with a gear-like profile, which are provided with a non-equidistant toothing or profile, in an economical manner and with a high degree of precision. Particular attention is paid to solving the problems caused by the non-equidistance during both dressing and grinding in the generating grinding process by means of an automated process. This concerns in particular the problem of feeding the non-equidistantly prepared dressing roll into the grinding worm in the correct position for dressing. Similarly, it is important to bring the grinding worm, which has been dressed in a non-equidistant manner, into the correct contact with the workpiece to be ground.

The solution to this problem provided by the invention is characterized in the method for dressing a multi-thread grinding worm with a multi-groove dressing roll by that at least two of the dressing surfaces are unevenly spaced from each other along the dressing tool axis of the dressing roll and/or that at least two of the dressing surfaces differ from each other in their shape in radial section, wherein the dressing of the grinding worm with the dressing roll comprises the steps:
a) Determination or measurement of the outer diameter of both the grinding worm and the dressing roll;
b) With stationary grinding worm:
   b1) Radial insertion of the dressing surfaces of the dressing roll into the worm threads in a first axial relative position between the tool axis and the dressing tool axis, wherein the insertion is carried out in such a way that the dressing surfaces extend into a range between 10 % and 90 % of the height of the worm threads;
      b1a) Determination of a first axial relative position between the grinding worm and the dressing roll when a dressing surface makes contact with a first flank of the grinding worm in a worm thread;
      b1b) Determination of a second axial relative position between the grinding worm and the dressing roll when a dressing surface comes into contact with a second flank of the grinding worm opposite the first flank in a worm thread;
      b1c) Determination of an axial center position between the first and second axial relative positions according to steps b1a) and b1b);
      b1d) Positioning of the dressing roll relative to the grinding worm in the determined axial center position of the worm thread and further radial insertion of the dressing roll into the worm threads until contact between a dressing surface and the grinding worm is detected;
      b1e) Storing the radial position between the dressing roll and the grinding worm determined in accordance with step b1d) when contact is made in accordance with step b1d);
   b2) Repeating of step b1) by radial insertion the dressing roll into further worm threads, wherein the insertion in the direction of the tool axis is offset by one worm thread, wherein the number of repetitions corresponds to the number of dressing surfaces minus 1;
c) Dressing the grinding worm with the dressing roll, wherein the dressing roll is moved into the relative axial center position between the grinding worm and the dressing roll in accordance with step b1c), at which the deepest radial position between the grinding worm and the dressing roll has been obtained in accordance with step b1e).

The determination or detection of the outer diameter of the grinding worm and/or the dressing roll in accordance with step a) above is preferably carried out by probing the outer circumference of the grinding worm and/or the dressing roll using a measuring element, in particular a structure-borne sound sensor. The structure-borne sound sensor, which is well known in the prior art, is installed in a component (e.g., in the tool spindle); as soon as contact is made with another component, the amplitude of the signal increases, from which contact can be inferred.

However, when determining or detecting the outer diameter, it is also taken in consideration to use, at least in part, existing data that is already available. The outer diameter of the dressing roll used is usually known. Since the distance between the tool axis (axis of the grinding worm) and the dressing tool axis is also known, it is sufficient to probe the dressing roll at the outer diameter of the grinding worm in order to determine or calculate the outer diameter of the worm.

When repeating step b1) above in accordance with step b2), different circumferential areas and/or axial areas of the grinding worm are preferably used. This prevents the grinding worm from being damaged by the described process.

When determining the first and second axial relative positions between the grinding worm and the dressing roll in accordance with steps b1a) and b1b) above, the tool axis and the dressing tool axis can be shifted axially relative to each other.

An alternative to this provides that, when determining the first and second relative positions between the grinding worm and the dressing roll in accordance with step b1a) and b1b) above, the tool axis and the dressing tool axis remain stationary relative to each other and the grinding worm is rotated around the tool axis, whereby the value of the axial displacement is determined from the angle of rotation of the grinding worm and the pitch of the worm threads.

In this context, it should be noted that, due to the known basic geometry of the grinding worm and, in particular, the known pitch at which the worm threads wind around the tool axis, the machine control system is able to deduce the corresponding axial displacements from the angle of rotation of the grinding worm.

When performing step b) above, the dressing roll preferably rotates.

The detection of contact in accordance with steps b1a), b1b) and b1d) above is preferably carried out by probing using a measuring element, in particular a structure-borne sound sensor. In general, there are of course other ways of detecting the contact in question. One possibility, for example, is to detect contact by observing the current consumption of a feed motor; as soon as contact is made with another component, the current consumption increases, from which contact can be inferred (i.e., contact is detected by force control).

The method for grinding a gear using a multi-thread grinding worm provides, according to the invention, that at least two of the worm threads are unevenly spaced from each other along the tool axis corresponding to the teeth of the gear and/or that at least two of the worm threads differ from each other in shape in radial section, wherein grinding the gear with the grinding worm comprises the steps of:
a) Determination of the outer diameter of both the grinding worm and the gear to be ground;
b) With the grinding worm rotating and the gear rotating in correspondence:
   b1) Radial insertion of the worm threads of the grinding worm into the toothing of the gear in a first axial relative position between the axes of the gear and the grinding worm, wherein the insertion is carried out in such a way that the worm threads extend into a range between 10 % and 90 % of the tooth height of the toothing;
      b1a) Determination of a first axial relative position between the axes of the gear and the grinding worm when a worm thread makes contact with a first flank of a tooth of the toothing;
      b1b) Determination of a second axial relative position between the axes of the gear and the grinding worm when a worm thread makes contact with a second flank of a tooth of the toothing opposite the first flank;
      b1c) Determining an axial center position of the tooth gap between the first and second axial relative positions according to steps b1a) and b1b);
      b1d) Positioning the grinding worm relative to the gear in the determined axial center position of the tooth gap and further radially insertion the grinding worm into the toothing of the gear until contact of a worm thread with the gear is detected;
      b1e) Storing the radial position between the grinding worm and the gear determined in accordance with step b1d) when contact is made in accordance with step b1d);
   b2) Repeating step b1) by radially insertion the grinding worm into further tooth gaps of the toothing, whereby the insertion is offset by one tooth in the circumferential direction of the toothing, wherein the number of repetitions corresponds to the number of worm threads minus 1;
c) Grinding the toothing of the gear with the grinding worm, wherein the grinding worm is inserted into the relative axial position between the gear and the grinding worm at which the deepest radial position between the gear and the grinding worm has been achieved in accordance with step b1e).

In this respect, the method for grinding the gear with the grinding worm is analogous to that described above for dressing the grinding worm with the multi-groove dressing roll.

The outer diameter of the grinding worm and/or gear is determined in accordance with step a) above, preferably by probing the outer circumference of the grinding worm and/or gear using a measuring element, in particular a structure-borne sound sensor. However, when determining the outer diameter in this way, it can of course also be taken in consideration to only use existing data that is already available. In the present case, this applies in particular to the outer diameter of the grinding worm. In most cases, data concerning the outer diameter of the gear to be ground is already available and can be accessed (i.e., without any measurement process). This means that the information is available so that the machine control system can check whether the threads of the grinding worm “dive” into the toothing.

When repeating step b1) above in accordance with step b2), different circumferential areas and/or axial areas of the toothing are again preferably used. This prevents damage to the gear. In this case, the machine control system can be used to conclude via the “electronic gear” between the workpiece spindle and the tool spindle to the corresponding position, taking into account the pitch of the worm threads.

When determining the first and second relative positions between the grinding worm and the gear in accordance with steps b1a) and b1b) above, the tool axis can be shifted axially relative to the gear.

When determining the first and second relative positions between the gear and the grinding worm in accordance with step b1a) and b1b) above, the tool axis and the axis of the gear can alternatively remain stationary relative to each other and the grinding worm can be subjected to an additional rotation, wherein the value of the axial displacement is determined from the angle of rotation of the grinding worm and the pitch of the worm threads.

The detection of contact in accordance with steps b1a), b1b), and b1d) above is preferably carried out by probing using a measuring element, in particular a structure-borne sound sensor. Here too, contact can be detected by monitoring the current of a feed motor.

If, after the grinding process described above (in particular for a first workpiece), another new gear is to be ground, it is preferable that the following steps be carried out for grinding it with the grinding worm:
a) Determination or measurement of the position of the worm threads above the tool axis (this position is known or stored after performing the grinding process described above, which can be referred to);
b) Before the insertion of the grinding worm into the toothing to be ground: Determination of the position of the teeth and/or tooth gaps of the gear over the circumference of the gear;
c) Evaluating of the determined position of the teeth and/or tooth gaps according to step b) and determining repeating distance patterns over the circumference of the gear;
d) Inserting the grinding worm into the toothing to be ground, wherein the position of the worm threads determined in step a) is aligned with the position of the teeth and/or tooth gaps of the gear with respect to the repeating distance patterns determined in step c).

Hereby, it is preferably provided that, when the grinding worm is inserted into the toothing to be ground in accordance with step d) above, an allowance mediation is performed on the basis of the position of the teeth and/or the tooth gaps of the gear determined in step b) above. The allowance mediation at gear grinding as such is well known in the prior art, for example, as described in EP 2 583 779 A1. This ensures a uniform minimum amount of material removal on the tooth flanks of the workpiece.

The position of the teeth and/or tooth gaps of the gear is preferably determined in accordance with step b) above using a contactless sensor, in particular an inductive or capacitive sensor. However, other sensors can also be used, in particular tactile sensors (probes).

The ratio of the number of teeth on the gear to the number of threads on the grinding worm must be an integer in the grinding process for a non-equidistant toothing described here.

According to a preferred embodiment of the invention, the tooth-shaped dressing surfaces of the dressing roll have a tooth thickness at a reference diameter, wherein at least two of the tooth thicknesses are of different sizes. In addition or alternatively, the tooth-shaped dressing surfaces of the dressing roll may have a pitch at a reference diameter, wherein at least two of the pitches are of different sizes. A further additional or alternative embodiment provides that the tooth-shaped dressing surfaces of the dressing roller have a maximum radial height, wherein at least two of the heights are of different sizes. A further possibility is that the tooth-shaped dressing surfaces of the dressing roller have a flank angle, wherein at least two of the flank angles are of different sizes.

Preferably, all tooth thicknesses, all pitches, all heights, and all flank angles of the dressing roll are of different sizes.

The difference between the above-mentioned largest and smallest tooth thickness is preferably at least 0.05 mm, particularly preferably at least 0.1 mm, and especially at least 0.2 mm. Accordingly, the difference between the largest and smallest pitch is also preferably at least 0.05 mm, particularly preferably at least 0.1 mm, and especially at least 0.2 mm.

Preferably, the dressing surfaces of the dressing roll have a diamond coating.

The proposed method makes it possible to perform the dressing process of the grinding worm perfectly and automatically using the dressing roll and to ensure that the dressing roll is inserted into the worm threads of the grinding worm in the correct position for dressing.

Similarly, when grinding non-equidistant toothings, it is possible to automatically, quickly, and precisely move the grinding worm into the correct relative position in the workpiece to be ground.

The proposed method makes it possible to automatically determine the correct position between the dressing roll and the grinding worm, as well as between the grinding worm and the gear to be ground.

Continuous generative gear grinding of the gear is possible, allowing for fast and cost-effective production of gears with non-equidistant toothing.

The described method is based on the fact that, for both dressing and grinding, the dressing roll is immersed in the grinding worm or the grinding worm is immersed in the gear toothing to be ground in the position for machining in which the deepest immersion of the dressing roll into the worm threads of the grinding worm or of the grinding worm into the gear toothing to be ground is possible. In this way, the correct relative position between the dressing roll and the grinding worm or between the grinding worm and the workpiece can be determined automatically, despite the non-equidistant design of the dressing roll and the grinding worm respectively.

In other words: In order to correctly perform the dressing process with a correspondingly non-equidistant dressing roll in the case of non-equidistant toothings, the proposed method provides for the dressing roll to be inserted several times into adjacent worm threads, centered there, and fed radially until the lowest possible feed amount is reached, which indicates the correct relative position between the dressing roll and the grinding worm. The same applies to the method for grinding a gear with non-equidistant toothing using a multi-thread grinding worm.

The sensors described for determining the diameter or the presence of contact can be structure-borne sound sensors. However, other sensors are also suitable in principle, in particular tactile sensors or those that operate inductively or capacitively, or even optical sensors. For the latter, reference is made, for example, to DE 10 2010 055 820 A1, EP 2 284 484 A1, and U.S. Pat. No. 4,547,674. As explained above, the current of a drive motor of an axis can also be monitored to determine contact.

When it is talked about grinding worms here, also similar worm-shaped tools are meant such as polishing worms. These typically have abrasive grains that are held together by a ceramic bond. However, electroplated CBN worms can also be used.

Although the grinding of a gear using a multi-thread grinding worm was mentioned here, this naturally also includes other workpieces with a gear-shaped profile.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows the radial section (or normal section, i.e., the axis of the dressing roll lies in the drawing plane) through a multi-groove dressing roll, which is intended for dressing a multi-thread grinding worm;

FIG. 2 shows the radial section through a grinding worm that is to be dressed with the dressing roll according to FIG. 1;

FIG. 3 shows the dressing roll, which-rotating itself-with the grinding worm stationary is positioned in a first axial relative position between the axis of the grinding worm and the dressing tool axis, wherein the dressing roll was moved into three adjacent worm threads and the dressing roll was moved radially toward the grinding worm until contact was made between the grinding worm and the dressing roll;

FIG. 4 shows the corresponding representation according to FIG. 3, wherein now—with the radial feed of the dressing roll to the grinding worm remaining unchanged—the dressing roll has been displaced in the direction of the dressing tool axis by a displacement amount (Δa) until contact is made between the grinding worm and the dressing roll;

FIG. 5 shows the grinding worm and the dressing roll; wherein the dressing roll has been arranged relative to the grinding worm in the axial position that lies exactly between the two positions according to FIG. 3 and FIG. 4;

FIG. 6 shows the dressing roll in the axial position according to FIG. 5, which has been moved radially toward the grinding worm until contact is made between the grinding worm and the dressing roll, wherein a radial feed amount of Δr1 has been covered until contact is made; and

FIG. 7 to FIG. 10 show the same situation as in FIGS. 4 to 6 in an analogous representation, wherein the dressing roll has now been moved into worm threads adjacent to those shown in FIGS. 4 to 6 (offset by one worm thread).

### DETAILED DESCRIPTION OF THE INVENTION

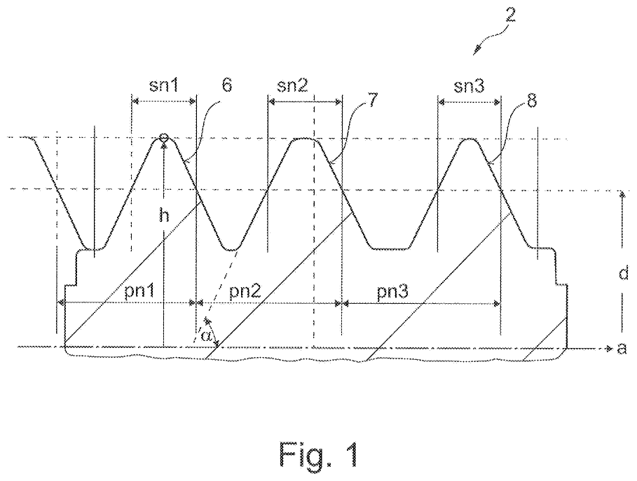

FIG. 1 shows a dressing tool 2 in the form of a multi-groove dressing roll (or its upper half), which has several dressing surfaces 6, 7, 8 that run parallel to each other circular around the axis a of the dressing roll 2. The dressing surfaces 6, 7, 8 are coated with diamond and are thus able to provide the individual threads of the grinding worm with the profile specified by the dressing surfaces 6, 7, 8 of the dressing roll 2 when engaging with a grinding worm to be dressed.

The appropriately dressed grinding worm is used to perform hard finishing on a gear toothing using the generating grinding method, which is well known in the prior art.

It is essential that the three dressing surfaces 6, 7, 8 are not all geometrically identical, but are arranged along the axis a of the dressing roller 2 with different or varying pitches.

If one considers a reference diameter d (which in this case lies approximately midway between the head circle and the foot circle of the tooth-shaped design shown), the respective values sn1, sn2, and sn3 result for the tooth thicknesses. Different values may exist for the tooth thicknesses, i.e., in contrast to previously known solutions, the tooth thicknesses are not all the same in this case.

Correspondingly, the pitches (i.e., the distances from tooth to tooth) pn1, pn2, and pn3 may also be different, which contrasts with prior art solutions, where the aim is always for the pitches to be the same.

The radial height h is also marked for one of the dressing surfaces (namely for dressing surface 6). In the embodiment, the radial heights h of all dressing surfaces 6, 7, 8 are the same; however, it is also possible to vary the heights.

The same applies to the flank angle α of the flanks of the dressing surfaces 6, 7, 8; this is marked for dressing surface 7. Here too, the angles as shown in the embodiment are all the same size. However, it is also possible to provide different angles for the individual dressing surfaces 6, 7, 8.

If a multi-thread grinding worm is dressed using such a dressing roll, it is profiled in such a way that, when the toothing is subsequently ground with the grinding worm, the result is a non-equidistant toothing, i.e., the tooth thicknesses, pitches, and other geometric dimensions are not all the same, but vary.

With regard to the above-mentioned magnitudes of the differences between the largest and smallest tooth thickness and between the largest and smallest pitch, it should be noted that these result in an offset in the pitch of the gear teeth of approximately 0.5° when grinding a toothing with the grinding worm that is dressed with the dressing roll 2. This then results in the characteristic of the non-equidistant toothing.

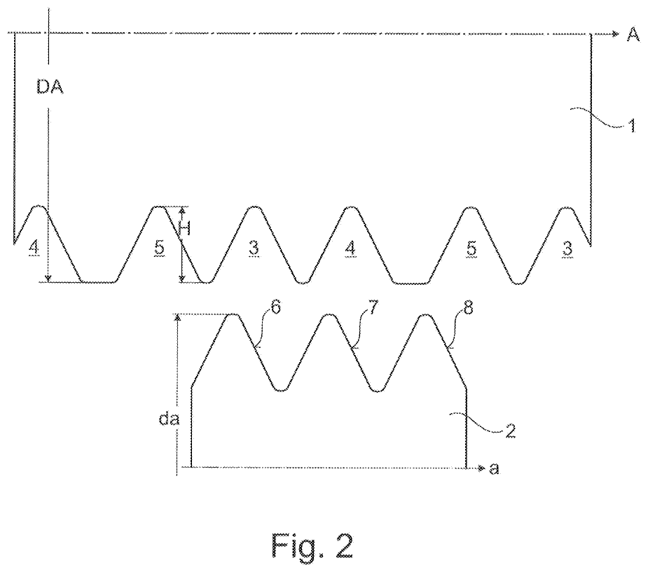

FIG. 2 shows how a grinding worm 1, which can rotate around the tool axis A, is to be dressed with the dressing roll 2. During the dressing process, the dressing roll 2 rotates around the dressing tool axis a. The dressing surfaces 6, 7, 8 are introduced into the parallel worm threads 3, 4, and 5 of the grinding worm 1 and profiled accordingly by means of the dressing surfaces 6, 7, 8. The dressing of a grinding worm by means of a multi-groove dressing roll is known in the prior art as such and does not need to be described in detail here.

The worm threads 3, 4, 5 extend over a height H. The grinding worm 1 has an outer diameter DA, the dressing roll 2 has an outer diameter da.

The number of dressing surfaces 6, 7, 8 is three in the embodiment and is generally indicated here by n.

The number of parallel worm threads 3, 4, 5 is also three in the embodiment and is generally indicated here by N.

While with previously known solutions, inserting the dressing roll 2 into the worm threads 3, 4, and 5 is usually not a problem because all dressing surfaces 6, 7, and 8 are basically identical in design, special problems arise in the present case of grinding non-equidistant Toothing because the dressing roll 2 only “fits” in a specific position relative to the grinding worm 1 or its worm threads 3, 4, and 5.

Thus, the following explanations serve the purpose how to carry out the dressing process correctly and to insert the dressing roll 2 into the worm threads of the grinding worm in the correct relative position.

To do this, proceed as follows.

First, the outer diameter DA of the grinding worm 1 and the outer diameter da of the dressing roll 2 are determined. This data must be known so that the machine control system (not shown) of the grinding machine in which the dressing process is carried out can determine whether, in the subsequent process, the dressing roll 2 “dives” into the worm threads 3, 4, 5 of the grinding worm 1 or whether the radially outer areas of the dressing surfaces 6, 7, 8 are opposite the radially outer areas of the worm threads 3, 4, 5, thus preventing “immersion”. In this case, the otherwise stationary (non-rotating) grinding worm 1 is rotated by a specified angle (e.g., 30° or 45°) around the tool axis A until the aforementioned immersion is possible. A structure-borne sound sensor (not shown) detects the contact between the dressing roll 2 and the grinding worm 1, so that the machine control automatically positions the grinding worm in such a way that the aforementioned immersion is possible.

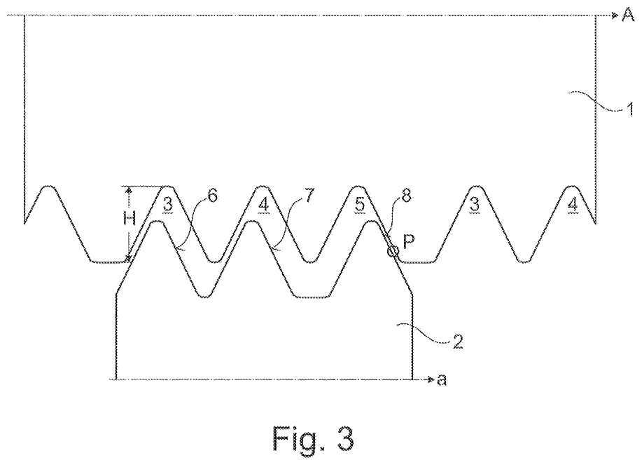

With the grinding worm 1 stationary (not rotating), the procedure is now as shown in FIG. 3: The dressing roll 2 is moved radially relative to the grinding worm 1 (from an initial position as shown in FIG. 2) until its dressing surfaces 6, 7, 8 extend into the area of the worm threads 3, 4, 5.

Radial immersion therefore initially takes place in the axial relative position of grinding worm 1 and dressing roll 2, as shown in FIG. 2. With regard to the radial feed of the dressing roll 2 relative to the grinding worm 1, it should be noted that sufficient immersion of the dressing surfaces 6, 7, 8 into the worm threads 3, 4, 5 must be ensured. In this regard, it should be noted that the aforementioned radial entry takes place in a range corresponding to between 10 % and 90 % of the height H (see FIG. 2) of the worm threads 3, 4, 5, i.e., the dressing surfaces 6, 7, 8 reliably extend beyond the head area of the worm threads 3, 4, 5, but are also sufficiently far away from the bottom of the worm threads. Preferably, the radially outer ends of the dressing surfaces 6, 7, 8 are located approximately in the middle of the height H of the worm threads 3, 4, 5, as can be seen in FIG. 3.

In this radial relative position, the rotating dressing roll 2 is now moved axially (to the right in FIG. 3) relative to the grinding worm 1 with the grinding worm at a standstill, until a dressing surface 6, 7, 8 makes contact with a first flank of the grinding worm 1 in a worm thread 3, 4, 5. This is marked with point P in FIG. 3. The machine control system registers the relative position between grinding worm 1 and dressing roll 2.

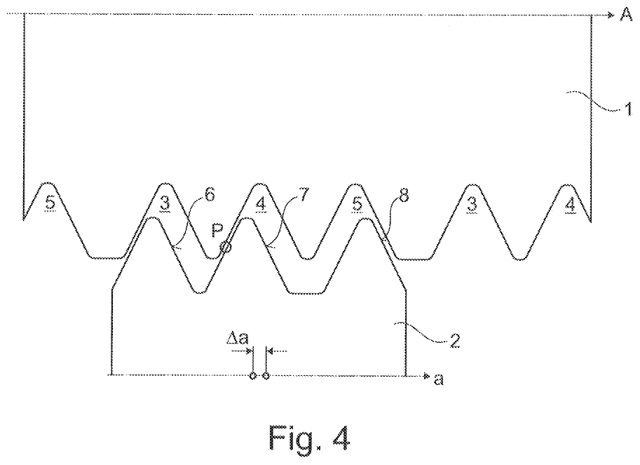

Subsequently, with the radial position between grinding worm 1 and dressing roll 2 remaining unchanged, the dressing roll is moved (to the left in FIG. 3) as shown in FIG. 4 until contact is made again between a dressing surface 6, 7, 8 with a second flank of the grinding worm 1 opposite the first flank (at point P in FIG. 3) in a worm thread 3, 4, 5. FIG. 4 shows that this is the case when the dressing roll 2 has been moved by an axial displacement amount of Δa; contact now occurs at point P as shown in FIG. 4. Again, the corresponding axial relative position of the dressing roll 2 is registered by the machine control system.

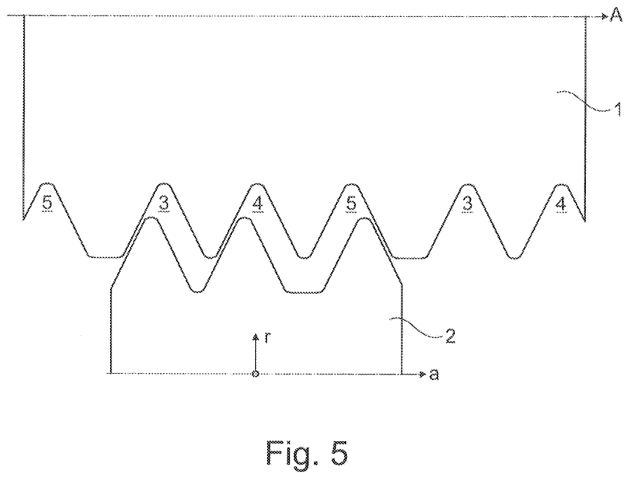

This now determines the axial center position of the worm thread as the (in particular arithmetic) mean of the first and second relative positions according to the two positions determined in FIGS. 3 and 4, i.e., the value of 0.5×Δa. Thus, a coordinate is stored as the average result between the two axial contact positions after probing the two flanks, which generally occurred in two different worm threads. The dressing roll 2 is moved back by this amount in order to be centered with respect to the two positions determined in accordance with FIGS. 3 and 4. This is shown in FIG. 5.

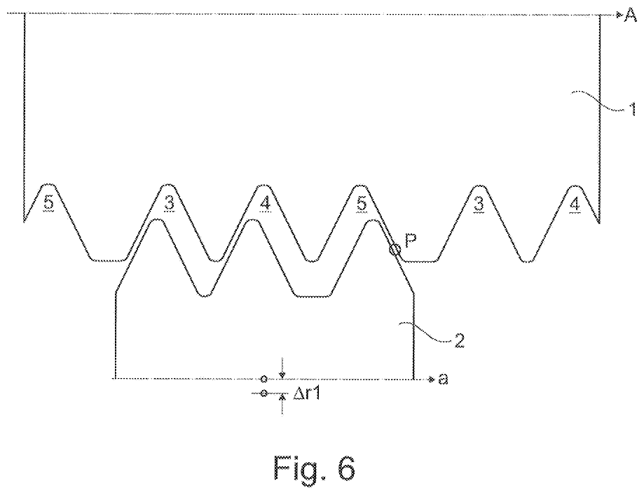

The radial feed of the dressing roll 2 (thus in FIG. 5 in the direction r) into the worm threads 3, 4, 5 now takes place until contact between a dressing surface 6, 7, 8 and the grinding worm 1 is detected. This is illustrated in FIG. 6, where it can be seen that contact is made at point P and that the dressing roll 2 had to be moved in by the radial feed amount Δr1 for this to happen. The resulting radial relative position between the tool axis A and the dressing tool axis a is registered and stored in the machine control system.

The process described in FIGS. 3 to 6 is now repeated in the relative position between grinding worm 1 and dressing roll 2, which is shifted or offset by one worm thread (see the numbering of the worm threads in FIGS. 3 to 10, into which the dressing surfaces 6, 7, 8 of the dressing roll are immersed).

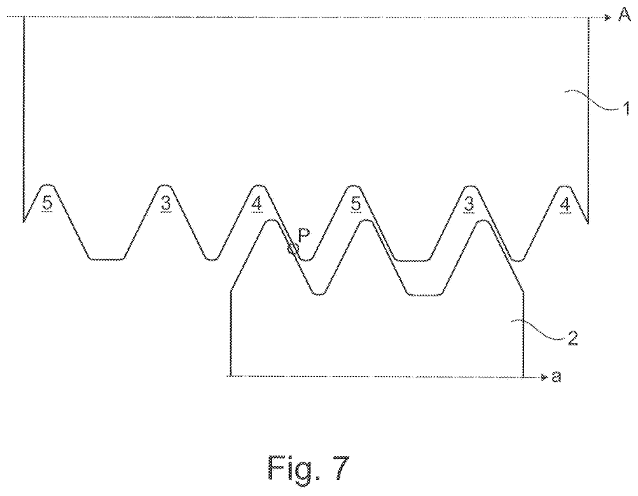

In this respect, FIG. 7 initially shows the situation corresponding to FIG. 3, with contact now being made at point P.

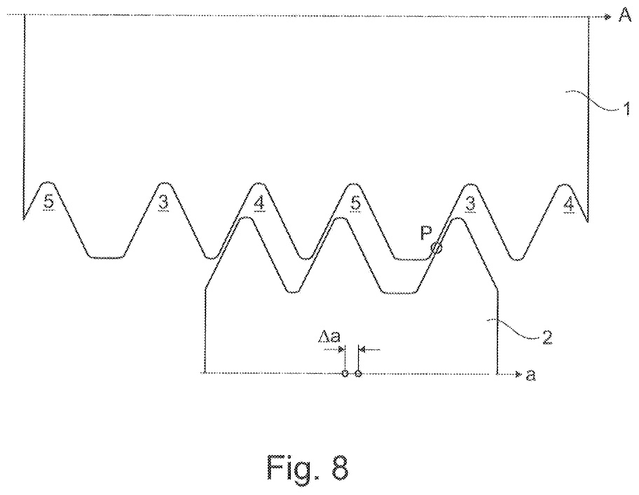

Subsequently, according to FIG. 8, the dressing roll 2 is moved (to the left in FIG. 7) until contact is made at point P according to FIG. 8. The displacement amount Δa was required for dressing roll 2 for this purpose.

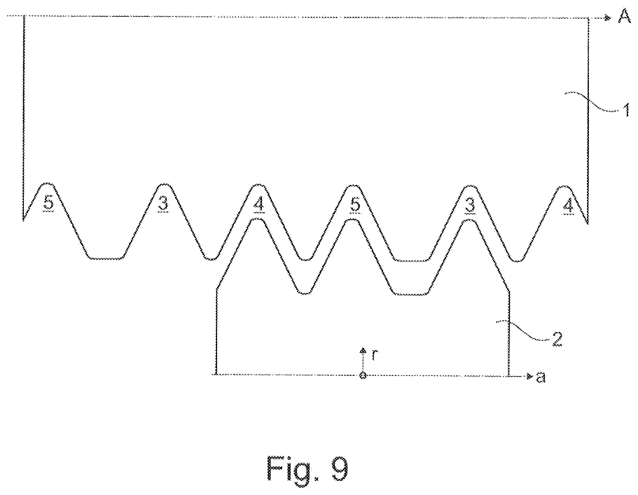

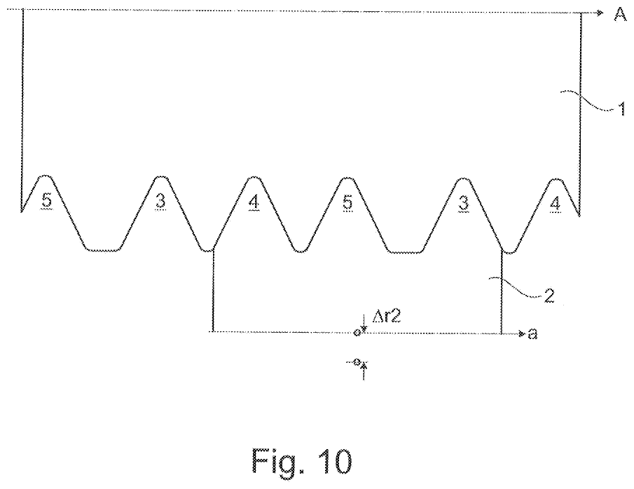

According to FIG. 9, the dressing roll 2 was again positioned centrally to the worm threads (i.e., axial backward movement of 0.5×Δa) in accordance with FIG. 5, in order to then push the dressing roll 2 radially (in the direction r according to FIG. 9) onto the grinding worm 1 until contact was made between the dressing roll and the grinding worm. This is shown in FIG. 10, where it can be seen that the radial feed amount of Δr2 was required for this. This is also stored in the machine control system.

The described process is repeated as many times as corresponds to the number n of dressing surfaces 6, 7, 8, i.e., three times in the embodiment.

The machine control registers the radial feed amounts, Δr1, Δr2, etc., and determines the largest value.

This specifies the “correct” relative position between the dressing roll and the grinding worm, i.e., the dressing profile of dressing roll 2 “fits” the worm threads of grinding worm 1.

The grinding worm 1 is then dressed using the dressing roll 2 inserted in this correct position.

The described method can be applied analogously when the finish dressed grinding worm 1 must be brought into contact with a workpiece to be ground.

In both cases, a systematic and automatable process is available to reliably prepare the dressing or grinding process before profiling the grinding worm for grinding a non-equidistant toothing or grinding such toothing.

While specific embodiments of the invention have been shown and described in detail to illustrate the inventive principles, it will be understood that the invention may be embodied otherwise without departing from such principles.

We claim:

1. A method for dressing a multi-thread grinding worm with a multi-groove dressing roll,
wherein the grinding worm has a plurality of worm threads which run parallel to one another around a tool axis,
wherein the dressing roll has a number of dressing surfaces which are arranged adjacent to one another along a dressing tool axis and which are tooth-shaped in radial section,
whereby, for dressing the grinding worm, the dressing roll is brought into engagement with the worm threads,
wherein at least two of the dressing surfaces are unevenly spaced from each other along the dressing tool axis of the dressing roll and/or at least two of the dressing surfaces differ from each other in shape in radial section,
wherein dressing the grinding worm with the dressing roll comprises the steps of:
a) Determination or measurement of the outer diameter of both the grinding worm and the dressing roll;
b) With stationary grinding worm:
b1) Radial insertion of the dressing surfaces of the dressing roll into the worm threads in a first axial relative position between the tool axis and the dressing tool axis, wherein the insertion is carried out in such a way that the dressing surfaces extend into a range between 10 % and 90 % of the height of the worm threads;
b1a) Determination of a first axial relative position between the grinding worm and the dressing roll when a dressing surface makes contact with a first flank of the grinding worm in a worm thread;
b1b) Determination of a second axial relative position between the grinding worm and the dressing roll when a dressing surface comes into contact with a second flank of the grinding worm opposite the first flank in a worm thread;
b1c) Determination of an axial center position between the first and second axial relative positions according to steps b1a) and b1b);
b1d) Positioning of the dressing roll relative to the grinding worm in the determined axial center position of the worm thread and further radial insertion of the dressing roll into the worm threads until contact between a dressing surface and the grinding worm is detected;
b1e) Storing the radial position between the dressing roll and the grinding worm determined in accordance with step b1d) when contact is made in accordance with step b1d);
b2) Repeating step b1) by radial insertion the dressing roll into further worm threads, wherein the insertion in the direction of the tool axis is offset by one worm thread, wherein the number of repetitions corresponds to the number of dressing surfaces minus 1; and
c) Dressing the grinding worm with the dressing roll, wherein the dressing roll is moved into the relative axial center position between the grinding worm and the dressing roll in accordance with step b1c), at which the deepest radial position between the grinding worm and the dressing roll has been obtained in accordance with step b1e).

2. The method according to claim 1, wherein the determination of the outer diameter of the grinding worm and/or the dressing roll according to step a) is carried out by probing the outer circumference of the grinding worm and/or the dressing roll by means of a measuring element, in particular by means of a structure-borne sound sensor.

3. The method according to claim 1, wherein, when repeating step b1) according to step b2), different circumferential areas and/or axial areas of the grinding worm are used.

4. The method according to claim 1, wherein, when determining the first and second axial relative positions between the grinding worm and the dressing roll according to steps b1a) and b1b), the tool axis and the dressing tool axis are axially displaced relative to each other.

5. The method according to claim 1, wherein, when determining the first and second axial relative positions between the grinding worm and the dressing roll according to step b1a) and b1b), the tool axis and the dressing tool axis remain stationary relative to each other and the grinding worm is rotated about the tool axis, wherein the value of the axial displacement is determined from the angle of rotation of the grinding worm and the pitch of the worm threads.

6. The method according to claim 1, wherein the dressing roll rotates during the execution of step b).

7. The method according to claim 1, wherein the determination of contact according to steps b1a), b1b) and b1d) is carried out by probing using a measuring element, in particular using a structure-borne sound sensor.

8. A method for grinding a gear using a multi-thread grinding worm, wherein the grinding worm has a number of worm threads that run parallel to each other around a tool axis, wherein the gear has teeth that are unevenly spaced from each other along the circumference of the gear and/or differ from each other in shape, wherein, corresponding to the teeth of the gear, at least two of the worm threads are unevenly spaced from each other along the tool axis and/or that at least two of the worm threads differ from each other in shape in radial section, wherein grinding the gear with the grinding worm comprises the steps of:
a) Determination of the outer diameter of both the grinding worm and the gear to be ground;
b) With the grinding worm rotating and the gear rotating in correspondence:
b1) Radial insertion of the worm threads of the grinding worm into the toothing of the gear in a first axial relative position between the axes of the gear and the grinding worm, wherein the insertion is carried out in such a way that the worm threads extend into a range between 10 % and 90 % of the tooth height of the toothing;
b1a) Determination of a first axial relative position between the axes of the gear and the grinding worm when a worm thread makes contact with a first flank of a tooth of the toothing;
b1b) Determination of a second axial relative position between the axes of the gear and the grinding worm when a worm thread makes contact with a second flank of a tooth of the toothing opposite the first flank;
b1c) Determining an axial center position of the tooth gap between the first and second axial relative positions according to steps b1a) and b1b);
b1d) Positioning the grinding worm relative to the gear in the determined axial center position of the tooth gap and further radially insertion the grinding worm into the toothing of the gear until contact of a worm thread with the gear is detected;
b1e) Storing the radial position between the grinding worm and the gear determined in accordance with step b1d) when contact is made in accordance with step b1d);
b2) Repeating step b1) by radially insertion the grinding worm into further tooth gaps of the toothing, whereby the insertion is offset by one tooth in the circumferential direction of the toothing, wherein the number of repetitions corresponds to the number of worm threads minus 1; and
c) Grinding the toothing of the gear with the grinding worm, wherein the grinding worm is inserted into the relative axial position between the gear and the grinding worm at which the deepest radial position between the gear and the grinding worm has been achieved in accordance with step b1e).

9. The method according to claim 8, wherein the outer diameter of the grinding worm and/or the gear is determined in accordance with step a) by probing the outer circumference of the grinding worm and/or the gear using a measuring element, in particular a structure-borne sound sensor.

10. The method according to claim 8, wherein, when repeating step b1) according to step b2), different circumferential areas and/or axial areas of the toothing are used.

11. The method according to claim 8, wherein, when determining the first and second axial relative positions between the grinding worm and the toothing of the gear according to steps b1a) and b1b), the tool axis is axially displaced relative to the gear.

12. The method according to claim 8, wherein, when determining the first and second axial relative positions between the gear and the grinding worm in accordance with steps b1a) and b1b), the tool axis and the axis of the gear remain stationary relative to each other and the grinding worm is subjected to an additional rotation, wherein the value of the axial displacement is determined from the angle of rotation of the grinding worm and the pitch of the worm threads.

13. The method according to claim 8, wherein the determination of contact according to steps b1a), b1b) and b1d) is carried out by probing using a measuring element, in particular using a structure-borne sound sensor.

14. The method according to claim 8, wherein the following steps are performed for grinding a further, new gear with the grinding worm:
d) Determination or measurement of the position of the worm threads above the tool axis;
e) Before the insertion of the grinding worm into the toothing to be ground: Determination of the position of the teeth and/or tooth gaps of the gear over the circumference of the gear;
f) Evaluating of the determined position of the teeth and/or tooth gaps according to step e) and determining repeating distance patterns over the circumference of the gear; and
g) Inserting the grinding worm into the toothing to be ground, wherein the position of the worm threads determined in step d) is aligned with the position of the teeth and/or tooth gaps of the gear with respect to the repeating distance patterns determined in step f).

15. The method according to claim 14, wherein, when the grinding worm is inserted into the toothing to be ground in accordance with step g), an allowance mediation is calculated on the basis of the position of the teeth and/or tooth gaps of the gear determined in step e).

16. The method according to claim 14, wherein the position of the teeth and/or tooth gaps of the gear is determined in accordance with step e) by means of a contactless sensor, in particular an inductive or capacitive sensor.
